(19) United States
(12) Patent Application Publication
(10) Pub. No.: US 2017/0160385 A1
(43) Pub. Date: Jun. 8, 2017

(54) VEHICLE PART WITH INTEGRATED SENSOR AND METHOD FOR PRODUCING SAME

(71) Applicant: Robert Bosch GmbH, Stuttgart (DE)

(72) Inventors: Burkhard Iske, Suzhou (CN); Albrecht Irion, Stuttgart (DE)

(21) Appl. No.: 15/320,355

(22) PCT Filed: Jun. 23, 2015
(86) PCT No.: PCT/EP2015/064024

§ 371 Date: Dec. 20, 2016

(30) Foreign Application Priority Data
Jul. 2, 2014 (DE) 102014212780.7

(51) Int. Cl. G01S 7/521; G01S 13/93; G01S 7/03; G01S 15/93

(52) U.S. Cl. CPC G01S 7/521; G01S 15/93; G01S 13/931; G01S 7/03; G01S 2013/9389

(57) ABSTRACT

A vehicle part having an integrated sensor for detecting the surroundings of a vehicle, a) the vehicle part being embodied as a plastic part, and at least one sensor being embedded in the plastic material of the vehicle part; or b) at least one sensor being fixedly connected to the vehicle part by adhesive bonding or welding, the at least one sensor encompassing at least one electronic component associated with surroundings detection, the electronic component being selected from signal generators, analog/digital converters, and amplifiers, or at least two of these components. A method for manufacturing such a vehicle part and to a vehicle having at least one such vehicle part, are also provided.

### FIELD

The present invention relates to a vehicle part having an integrated sensor for detecting the surroundings of a vehicle.

The present invention further relates to a method for manufacturing such a vehicle part.

### BACKGROUND INFORMATION

Modern vehicles are equipped with a plurality of assistance systems in order to enhance safety and assist the driver in carrying out driving maneuvers. In order to function, these assistance systems require information regarding the surroundings of the vehicle. Several sensors, based for example on ultrasound, radar, or lidar, are usually placed for this purpose on the exterior of a vehicle. The sensors emit waves, and recognize objects in the surroundings based on waves or echoes that are radiated back.

When possible, the sensors are disposed in concealed fashion behind vehicle parts in order to protect the sensors from damaging environmental influences such as moisture or dirt, and to impair as little as possible the aesthetic appearance of the vehicle. Fastening elements are necessary in order to connect the sensors to such vehicle parts, for example bumpers or decorative strips. On the one hand these fastening elements increase the complexity of the respective vehicle parts in the context of production, and on the other hand further disadvantages result, for example in the context of configuration of the vehicle parts, since consideration must be given to these fastening elements.

German Patent Application No. DE 10 2011 122 346 A1 describes a radar device that is disposed behind a bumper. The radar device encompasses a radar unit having a housing and having a mount by way of which the radar unit is fastenable to a vehicle component. The mount is furthermore configured so that it encompasses an absorption element for radar radiation. This absorption element is configured and disposed so that reflections of the radar radiation at vehicle parts are suppressed.

German Patent No. DE 102 42 526 A1 describes a method for integrating antenna elements into plastic components of vehicles. The antenna elements are introduced between a plastic support and a paint layer. The antenna elements can be injection-embedded upon configuration of the plastic support, or can be adhesively bonded onto the plastic support as stamped parts. A radar unit is connectable to the antenna via a coaxial lead connected to the antenna element.

The existing art is disadvantageous in that complete integration of a sensor into a vehicle part is not accomplished, so that mounts and connecting elements are still necessary.

### SUMMARY

In accordance with example embodiments of the present invention, a vehicle part having an integrated sensor for detecting the surroundings of a vehicle is provided,
a) the vehicle part being embodied as a plastic part, and at least one sensor being embedded in the plastic material of the vehicle part, or
b) at least one sensor being fixedly connected to the vehicle part by adhesive bonding or welding,
   the at least one sensor encompassing at least one electronic component associated with surroundings detection, and the electronic component being selected from signal generators, analog/digital converters, and amplifiers, or at least two of those components.

The vehicle part can be embodied, for example, as a bumper or a decorative strip. It is furthermore conceivable for the vehicle part to be part of the vehicle bodywork, for example a wheel well or a door.

According to the present invention, at least one sensor forms an integrated component with the vehicle part. In the first variant embodiment a) of the invention, at least one sensor is already embedded into the vehicle part in the context of its manufacture, and is thus fixedly connected to the vehicle part. In another variant b) of the invention, the vehicle part is firstly manufactured separately, and later the at least one sensor is fixedly connected to the vehicle part to yield a unit.

In both cases what is produced is a vehicle part having at least one integrated sensor, which is easy to handle. The orientation of the sensors relative to the vehicle part is fixedly predefined and does not subsequently change, so that laborious alignment and calibration of the sensors in the context of assembly of a vehicle can be very largely omitted.

In an embodiment of the present invention, the sensor is selected from ultrasonic sensors and radar sensors.

In the case of ultrasonic sensors the sensor should be disposed as close as possible to the externally located surface of the vehicle part, so that acoustic waves sent out from the ultrasonic sensor can be effectively radiated and ultrasonic echoes reflected from objects can be received again by the ultrasonic sensor. If the ultrasonic sensor is embedded into the vehicle part in accordance with variant a), the sensor is then preferably disposed in the interior of the vehicle part in such a way that the ultrasonic converter of the ultrasonic sensor is located close to an outward-facing surface of the vehicle part. “Close” means in this case that acoustic propagation is not impaired by the material of the vehicle part. Suitable materials of the vehicle part encompass in this case, for example, thermoplastics such as, for example, acrylonitrile-butadiene-styrene (ABS).

If the sensor is a radar-based sensor, a separate housing of the radar sensor (radome) can then advantageously be omitted. For that purpose the radar sensor is once again disposed in the interior of the vehicle part in such a way that the emitted radar radiation passes through the material of the vehicle part and radar echoes can be received again by the antennas of the radar sensor.

The at least one sensor integrated into the vehicle part encompasses not only the signal converter, i.e., the ultrasonic membrane in the case of ultrasonic sensors or the antenna in the case of radar sensors, but also at least one electronic component associated with surroundings detection. This electronic component associated with surroundings detection encompasses signal generators, analog/digital converters, and amplifiers, or at least two of those components. In a preferred variant the electronic component encompasses all components that are necessary for generating a signal, emitting that signal, and receiving signal echoes. The electronic component thus encompasses in particular a signal generator, a digital/analog converter, a transmission amplifier, a reception amplifier, and an analog/digital converter.

In further variants of the present invention the sensor integrated into the vehicle part furthermore encompasses means for signal evaluation.

The sensors, for example the respective ultrasonic- or radar-based sensors, send out signals in the context of surroundings detection. These signals are reflected from objects in the surroundings of the vehicle and are detected again by the sensors as signals. In the context of evaluation of the received signals, on the one hand interference that can result, e.g., from general background noise, from the influence of the vehicle part itself, or from signals of other devices or other sensors, is removed. On the other hand, the signals are evaluated in order to recover data regarding the surroundings of the vehicle. For example, the distance of the object that has reflected the signal can be determined from the transit time between emission of the signal and reception of the signal echo, together with the known propagation speed of the signal.

In a preferred variant of the present invention, the at least one sensor integrated into the vehicle part furthermore encompasses means for transferring information to a control device.

Such transfer can occur in principle in wire-based or wireless fashion, the control device having corresponding means for receiving the transferred information. The information can encompass, in particular, data regarding the distance of objects in the surroundings of a vehicle, or their size or relative position with respect to the vehicle. The control device can combine these information items and make them available to further systems in the vehicle, for example a parking assistance system or other driver assistance systems. Depending on the embodiment, these assistance systems can also be implemented in the control device itself.

Preferably the means for transferring information to a control device are embodied as a transceiver for a CAN bus. The use of such standardized bus systems considerably simplifies wiring, since each sensor does not need its own direct cable connection to the control device.

A further aspect of the present invention relates to a method for manufacturing a vehicle part of this kind having an integrated sensor,
a) the vehicle part being embodied as a plastic part and, in the context of manufacture thereof, at least one sensor being inserted into a mold and overmolded with plastic, or
b) at least one sensor being fixedly connected to the vehicle part by welding or adhesive bonding.

In variant a) of the method according to the present invention, firstly a mold for manufacturing the vehicle part is furnished. The at least one sensor is inserted into this mold. Plastic is then injected into the mold, the sensor being overmolded with plastic, the at least one sensor encompassing at least one electronic component associated with surroundings detection.

Depending on the variant embodiment, the sensor is received completely in the interior of the vehicle part. In a further variant embodiment, connector elements with which the sensor can, for example, be connected to a control device project out of the vehicle part so that electrical contacting is possible. In another variant embodiment the sensor still projects partly out of the vehicle part so that, in particular, electrical contacting of the sensor is possible without difficulty.

In embodiment b) of the method, firstly the vehicle part is manufactured as usual. Then a sensor is fixedly connected to the vehicle part by welding or adhesive bonding so that they form a unit.

In order to limit the functioning of the ultrasonic- or radar-based sensor as little as possible, it is preferred for the material thickness of the vehicle part to be as thin as possible in the region at which the sensor is fastened by adhesive bonding or welding.

In both cases, the at least one sensor and the vehicle part form a unit. A relative movement of the at least one sensor with respect to the vehicle part is no longer possible.

Advantageously, once an alignment of the sensor relative to the vehicle part has been performed it is, thus, always retained, so that alignment of the at least one sensor after installation of the vehicle part in a vehicle is superfluous.

A further aspect of the present invention relates to a vehicle that encompasses at least one such vehicle part.

With the exemplary vehicle part, at least one sensor for detecting the surroundings of a vehicle is connected to a vehicle part with no need for a mount. The vehicle part can thus be manufactured more simply, and is lighter because no additional material is required for a mount.

It is furthermore possible to dispose the sensors used for surroundings detection in concealed fashion in the vehicle part. It is easily possible in this context to place the converters of the sensors, i.e., the membrane in the case of an ultrasonic sensor and the antenna in the case of a radar sensor, just below the surface of the vehicle part. There is thus almost no impairment of the sensors in terms of their function, and the vehicle's appearance is not influenced by installation of the sensors.

The elimination of additional mounts for the sensors also simplifies the design of the vehicle parts, since it is no longer necessary to consider the space requirement and mechanical properties of the mounts.

In addition, especially in the context of the use of radar sensors, a separate housing for those sensors is superfluous. The radar sensor can be disposed in the interior of a vehicle part without a protective shell (radome), the sensor being protected from environmental influences by the material of the vehicle part. The result is that on the one hand the material for the radome can be eliminated, and on the other hand the performance of the sensor is improved because the previously required radome absorbed some of the emitted signals of the sensor.

### BRIEF DESCRIPTION OF THE DRAWINGS

FIG. 1 shows a vehicle part having sensors disposed in the interior.

FIG. 2 shows a vehicle part having a sensor adhesively bonded on.

FIG. 3 shows a vehicle having a bumper according to the present invention.

### DETAILED DESCRIPTION OF EXAMPLE EMBODIMENTS

In the description below of exemplifying embodiments of the present invention, identical or similar components and elements are labeled with identical reference characters, repeated description of those components or elements in individual cases being omitted. The Figures depict the subject matter of the present invention merely schematically.

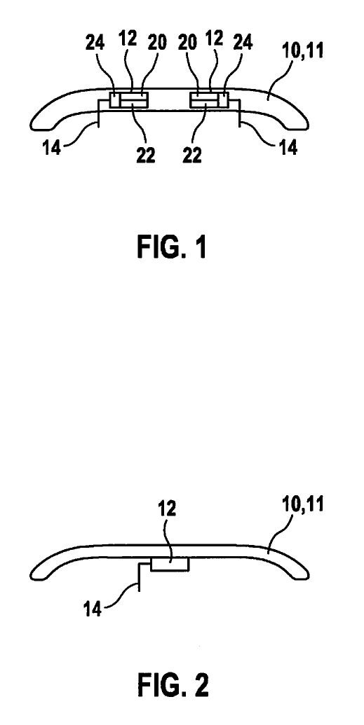

FIG. 1 shows a vehicle part 10 that is embodied as a bumper 11. Bumper 11 is made of a plastic material, and in the exemplifying embodiment depicted in FIG. 1 two sensors 12 are disposed in its interior.

Sensors 12 are configured to detect the surroundings of a vehicle 1. Sensors 12 each encompass for that purpose a converter 20, an electronic component 22, and means 24 for transferring information. In the case of an ultrasound-based sensor 12, converter 20 encompasses an ultrasonic membrane and corresponding components for driving the membrane. In the case of the embodiment as a radar-based sensor 12, converter 20 is embodied as an antenna. Sensor 12 furthermore encompasses electronic component 22 for controlling converter 20. This electronic component 22 can encompass several signal generators, analog/digital converters, and amplifiers. Electronic component 22 can furthermore also encompass means (e.g., a signal evaluation unit) for evaluating signal echoes received by converter 20.

Converter 20 is used to emit signals and to receive echoes reflected from objects in the surroundings of a vehicle 1.

Depending on the variant embodiment, sensor 12, using means 24 for transferring information, can send the received signals as raw data for evaluation to a control device 16 or, if sensor 12 encompasses its own means for evaluating signals, can directly transfer information regarding objects recognized in the surroundings. In the embodiment depicted in FIG. 1, communication occurs in wire-based fashion with the aid of a connector lead 14 that is embodied as a data bus.

In the embodiment depicted in FIG. 1, sensors 12 are received completely, except for their connector leads 14, in the interior of vehicle part 10. Sensors 12 are thereby on the one hand well protected from environmental influences; on the other hand, the alignment of sensors 12 relative to vehicle part 10 is thereby fixedly predefined.

FIG. 2 depicts a further variant embodiment of a vehicle part 10 according to the present invention. Vehicle part 10 is again embodied as a bumper 11. In contrast to the embodiment described with reference to FIG. 1, however, sensor 12 is not received in the interior of vehicle part 10 but instead is connected to vehicle part 10 on a side that later faces toward the vehicle interior. This connection can be produced, for example, by adhesive bonding or welding. The thickness of vehicle part 10 in the region on which sensor 12 is disposed can be reduced as compared with other regions of vehicle part 10. Damping of the signals emitted and received by sensor 12 is thereby minimized.

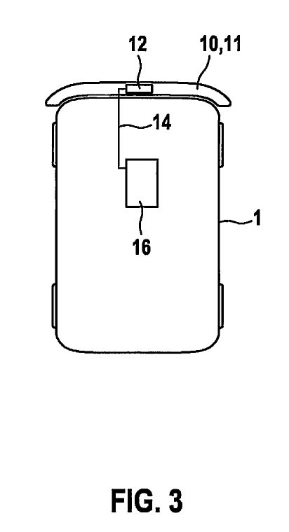

FIG. 3 depicts a vehicle 1 that encompasses a vehicle part 10 according to the present invention.

Vehicle 1 encompasses a vehicle part 10 that is embodied as bumper 11. A sensor 12 is disposed in the interior of bumper 11. Sensor is completely enclosed, except for its connector lead 14, by the material of bumper 11. With its connector lead 14, sensor 12 is in communication with a control device 16 of vehicle 1. Sensor 12 encompasses all the components that are necessary for recognition of an object in the surroundings of vehicle 1. These encompass a converter 20 (not depicted here) with which signals can be emitted and received, as well as the pertinent electronic component 22 (not depicted here) including the signal generators, amplifiers, and analog/digital converters. In a preferred variant of the invention sensor 12 furthermore encompasses means for evaluating the received signal echoes, so that sensor 12 can supply, via connector lead 14, information that is already evaluated. This evaluated information encompasses, for example, the distance of an object from vehicle 1 or the relative position of an object with respect to vehicle 1.

The present invention is not limited to the exemplifying embodiments described here and to the aspects emphasized therein. A plurality of modifications are instead possible within the range indicated by the claims in the context of the activity of one skilled in the art.

1-8. (canceled)

9. A vehicle part having an integrated sensor for detecting the surroundings of a vehicle, wherein one of:
a) the vehicle part is embodied as a plastic part, and at least one sensor is embedded in plastic material of the vehicle part, or
b) the at least one sensor being fixedly connected to the vehicle part by adhesive bonding or welding;
wherein the at least one sensor includes at least one electronic component associated with surroundings detection, the at least one electronic component being at least one of: a signal generator, an analog/digital converter, and an amplifier.

10. The vehicle part as recited in claim 9, wherein the at least one electronic component includes at least two of the following: a signal generator, an analog/digital converter, and an amplifier.

11. The vehicle part as recited in claim 9, wherein the sensor is selected from ultrasonic sensors and radar sensors.

12. The vehicle part as recited in claim 9, wherein the sensor includes a signal evaluation device.

13. The vehicle part as recited in claim 9, wherein the sensor includes means for transferring information to a control device.

14. The vehicle part as recited in claim 13, wherein the means for transferring information to the control device is a transceiver for a CAN bus.

15. The vehicle part as recited in claim 9, wherein the vehicle part is one of a bumper a decorative strip, a wheel well, or a door.

16. A method for manufacturing a vehicle part having an integrated sensor for detecting the surroundings of a vehicle, the method comprising one of:
a) forming the vehicle part as a plastic part and, at least one sensor being inserted into a mold for the plastic part and is overmolded with plastic, or
b) providing the vehicle part and fixedly connecting the at least one sensor to the vehicle part by welding or adhesive bonding;
wherein at least one sensor includes at least one electronic component associated with surroundings detection, the at least one electronic component being at least one of: a signal generator, an analog/digital converter, and an amplifier.

17. A vehicle having at least one vehicle part, vehicle part having an integrated sensor for detecting the surroundings of a vehicle, wherein one of:
a) the vehicle part is embodied as a plastic part, and at least one sensor being embedded in plastic material of the vehicle part, or
b) the at least one sensor being fixedly connected to the vehicle part by adhesive bonding or welding;
wherein the at least one sensor includes at least one electronic component associated with surroundings detection, the at least one electronic component being at least one of: a signal generator, an analog/digital converter, and an amplifier.
